(19) United States
(12) Patent Application Publication
(10) Pub. No.: US 2004/0210683 A1
(43) Pub. Date: Oct. 21, 2004

(54) Embedding driver patches

(76) Inventors: Patrick L. Connor, Portland, OR (US); Mark V. Montecalvo, Hillsboro, OR (US); Scott P. Dubal, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/421,556

(22) Filed: Apr. 21, 2003

(51) Int. Cl. G06F 3/00

(52) U.S. Cl. 710/15

(57) ABSTRACT

A method of updating a device driver is disclosed.

### BACKGROUND

1. Field

This disclosure relates to device drivers and in particular, to modifying device drivers.

2. Background Information

Computer systems and other information processing systems may include devices such as, but not limited to, input devices, output devices and storage devices. Examples of input devices include but are not limited to a mouse, a keyboard, a microphone; examples of output devices include but are not limited to a screen, a printer, and an audio speaker.

Typically, most programs, including operating systems, access devices using relatively generic commands. However, such devices typically respond to a specialized set of commands. A device driver is a program for controlling a device. The driver typically accepts the generic commands from a program and translates them to the specialized commands understood by the device.

The notion of device driver forward compatibility suggests that it may be desirable for a device driver to run on a device that is available today, and also on future devices and/or versions that are not yet released or developed. This may arise when new versions of the device will be released although the original drivers are still in use. One method of forward compatibility involves having the new device function using currently deployed drivers. However, there are at least two drawbacks to this method. First, although there may be some level of compatibility, an existing driver may not be able to take advantage of some or all of the features of the new device. Second, if a new device is shipped with errata, those errata may interfere with or reduce the amount of compatibility.

One approach to this problem is to provide the device with a firmware interface. This layer may then be programmed to mask the device errata. A disadvantage of this solution is that firmware interface architectures may be more expensive due to the processor or controller which may execute the firmware or microcode.

Another approach to this problem is to provide or make available new drivers to users, for example, by CD or via the Internet. A disadvantage of this approach includes the inconvenience of user intervention and the difficulty of correct installation. In addition, system functionality can be reduced if the upgrade is not supported by existing drivers. So, for example, if the new device comprises a network adapter, and it is not compatible with the existing driver, then the user may thereby be unable to access the network to obtain an updated driver.

Thus, there is a need for a better solution to the problem of device driver forward compatibility.

### BRIEF DESCRIPTION OF DRAWINGS

Subject matter is particularly pointed out and distinctly claimed in the concluding portion of the specification. The subject matter, however, both as to organization and method or operation, together with objects, features, and advantages thereof, may best be understood by reference to the following detailed description, when read with the accompanying drawings in which:

FIG. 1 is a flowchart showing an embodiment of the claimed subject matter;

FIG. 2 is a block diagram showing another embodiment of the claimed subject matter.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components, and circuits have not been described in detail so as not to obscure the claimed subject matter.

An embodiment of the claimed subject matter comprises an improved method of and apparatus for updating a device driver. In one embodiment, a device includes a storage medium to store a driver patch. The driver patch may be used to update the device driver.

The term “patch” as used herein refers to a program fix including, but not limited to the insertion, deletion, or replacement of any of the following: one or more lines of machine code, one or more lines of source code, or one or more entire executable modules.

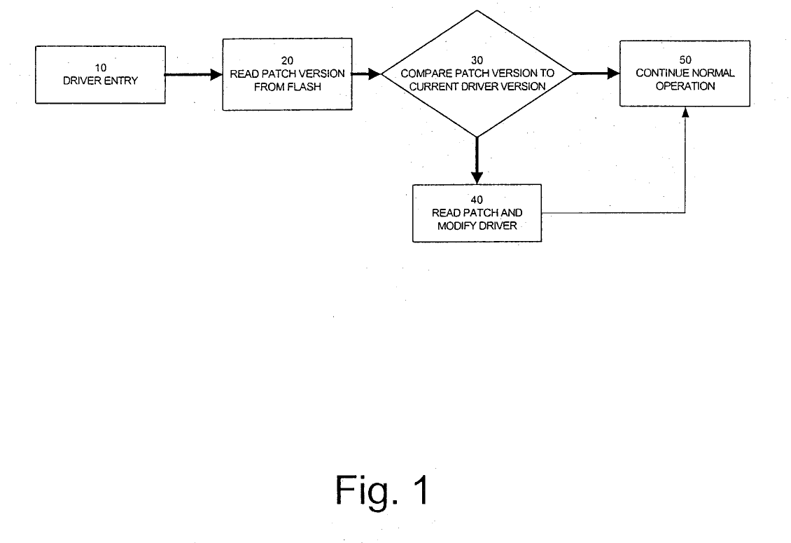

FIG. 1 is a flowchart showing the operation of an embodiment of the claimed subject matter. In block 10, a driver entry routine is executed. In this particular embodiment, a driver entry routine comprises a part of a device driver and may be executed either during or immediately after the loading and/or initialization of the driver. The driver may be loaded during bootup of the system or on-demand or by any other technique known or hereinafter developed. The claimed subject matter is therefore not limited in this respect. In this embodiment the driver entry routine may include instructions directing a host processor to read a patch version identification from a storage medium of an associated device. This is illustrated in block 20. In this embodiment, at diamond 30 the patch version identification is compared with the version of the current driver. The results of this comparison may be used to determine whether to update the driver with the patch.

In one embodiment, the comparison results are used as follows. If the patch version identification is not newer than the current driver, then normal operation continues and the driver is not updated, as shown in block 50. If, however, the patch version is newer, then it may be desired that the driver be updated. In block 40, the patch is read and the driver is modified accordingly.

Thus it can be seen that, in this particular embodiment, a driver may be automatically updated when, for example, a device, or another version of a device, is added to a system. The claimed subject matter, however, is not limited to this particular embodiment. There is no need for the user to intervene by inserting a CD, going to some website on the Internet, et al. Instead, the driver patch may be stored directly on a storage medium such as one included as part of the device, for example, and the driver may be patched during the loading and initialization of the device

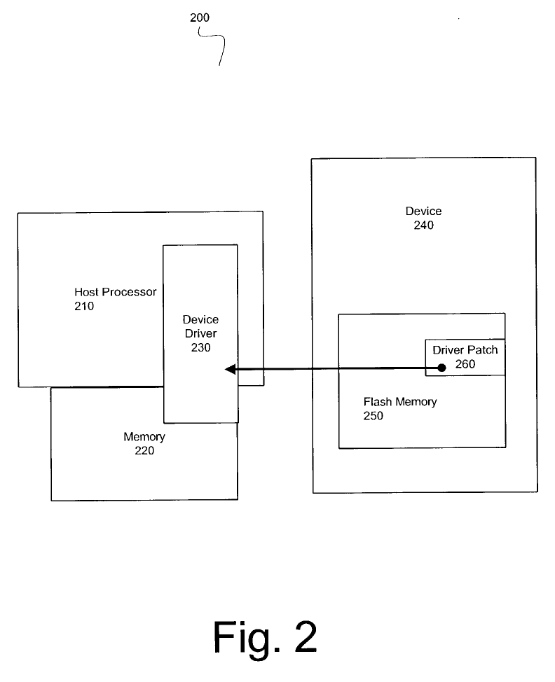

FIG. 2 shows a block diagram of an embodiment of the claimed subject matter. System 200 includes a host processor 210, a memory 220, a device driver 230, and a device 240. In this embodiment, the device includes flash memory 250 on which is stored a driver patch 260. Of course, the claimed subject matter is not limited in this respect. Driver patch 260 may, for example, be stored on any type of memory, including any non-volatile memory. The operation of this embodiment is as follows. Device driver 230 may be loaded during bootup or on demand or any other appropriate time. When the driver is loaded and/or initialized, certain instructions are executed. These instructions may include directing host processor 210 to read driver patch 260 from flash 240 and update the driver with the patch. In some embodiments, the host processor may first read the driver patch version from flash 240 and compare it with the version of the current driver. In this embodiment, if the patch version is newer, then the driver may be updated. However, if the patch version is not newer, then in this embodiment the driver is not updated.

In another embodiment, flash 250 (or any other type of data storage) may include multiple driver patches. For example, there may be multiple versions of drivers deployed, each requiring its own patch. Again, the claimed subject matter is not limited in this respect. In this embodiment, the particular version of the driver being used may be determined, and then the corresponding patch may be read from flash 250 and used to update the driver 230.

While certain features of the claimed subject matter have been illustrated and described herein, many modifications, substitutions, changes and equivalents will now occur to those skilled in the art. It is, therefore, to be understood, that the appended claims are intended to cover all such modifications and changes.

What is claimed is:

1. An apparatus for modifying a device driver comprising:
a device comprising a storage medium; and
a driver patch stored on the storage medium.

2. The apparatus of claim 1 wherein the apparatus is adapted to update the device driver with the driver patch after it is determined to update the device driver.

3. The apparatus of claim 2 wherein the apparatus is adapted to compare a patch version identification to the device driver to determine whether to modify the device driver.

4. The apparatus of claim 1 further comprising at least one more driver patch stored on the storage medium.

5. The apparatus of claim 4 wherein the apparatus is adapted to determine which patch to use based, at least in part, on the device driver version.

6. The apparatus of claim 2 wherein the device comprises a network interface controller.

7. The apparatus of claim 2 wherein the storage medium comprises nonvolatile memory.

8. A method of updating a device driver for a device which comprises a storage medium, comprising:
updating the device driver with a driver patch stored on the storage medium.

9. The method of claim 8 further comprising:
before updating the device driver, determining whether to update the device driver.

10. The method of claim 9 wherein the determining further comprises:
comparing a patch version identification with the stored version of the device driver.

11. The method of claim 9 wherein the device driver is updated without user intervention.

12. The method of claim 9 wherein the device comprises a network interface controller.

13. The method of claim 9 wherein the storage medium comprises nonvolatile memory.

14. The method of claim 9 wherein the storage medium comprises EEPROM.

15. A method comprising loading a driver patch onto a storage medium of a device.

16. The method of claim 15 wherein the device comprises a network interface controller.

17. The method of claim 15 further comprising updating a driver with the driver patch.

18. The method of claim 17 further comprising loading at least one more driver patch onto the storage medium.

19. The method of claim 17 further comprising determining whether to update a driver prior to updating the driver.

20. The method of claim 19 wherein the determining further comprises comparing version identifications.

21. An article comprising instructions which when executed result in updating a device driver with a patch stored on a storage medium on a corresponding device.

22. The article of claim 21 further comprising instructions which when executed determine whether to update the device driver.

23. The article of claim 22 further comprising instructions which when executed compare a patch version identification of said patch with the stored device driver version to determine whether to update the device driver

24. The article of claim 22 further comprising at least one more patch and instructions which when executed determine which one of a plurality of patches stored on the device to use to update the device driver.

25. The article of claim 22 wherein the device comprises a network interface controller.

26. The article of claim 22 wherein the storage medium comprises nonvolatile memory.
